(19) United States
(12) Patent Application Publication
(10) Pub. No.: US 2015/0208853 A1
(43) Pub. Date: Jul. 30, 2015

(54) Infusion Core with Muddler

(71) Applicant: Epoca International, Inc., Boca Raton, FL (US)

(72) Inventors: Brian Melzer, Boca Raton, FL (US); Matthew L. Chin, New York, NY (US); Gareth Brown, Jersey City, NJ (US)

(73) Assignee: Epoca International, Inc., Boca Raton, FL (US)

(21) Appl. No.: 14/166,121

(22) Filed: Jan. 28, 2014

(51) Int. Cl. A47J 31/44; A23L 2/56; A47J 43/044

(52) U.S. Cl. CPC A47J 31/4403; A47J 43/044; A23L 2/56; A23V 2002/00; A47J 2043/04427

(57) ABSTRACT

Systems and methods for flavoring beverages, and particularly to an infusion core that can be inserted into a beverage container, and an associated muddler. A system for flavoring a beverage includes a core locatable inside a larger beverage container, the core having a wall including a plurality of apertures therein. A muddler is usable inside the core for mashing a flavoring element, the muddler including a skirt to prevent pieces of the flavoring element from escaping from the core.

### FIELD OF THE INVENTION

The present application relates to systems and methods for flavoring beverages, and particularly to an infusion core that can be inserted into a beverage container, and an associated muddler.

### BACKGROUND

There are many ways to flavor beverages, but many people increasing desire to flavor beverages using only natural ingredients such as fresh fruit and herbs. A typical method of infusing a beverage such as water or tea with a fruit flavor is to place the liquid and cut up fruit into a large drinks dispenser, and to allow the flavor of the fruit to slowly infuse into the liquid over several hours. This method suffers from several disadvantages. First, it can take an average of about 6 hours to infuse the water with sufficient flavor. This means that not only does the drinking of such an infused beverage have to be planned well in advance, but typically it is desired to keep the beverage fresh and cool by refrigerating it, and a suitable amount of space must be available in a refrigerator for the drinks dispenser. Alternatively, ice can be added to the beverage once it has been infused, but this dilutes the taste of the fruit that has been built up.

It is known to crush certain herbs, particularly leaves such as peppermint, using a muddler. A muddler is a bartender's tool, used like a pestle to mash fruits, herbs, and/or spices in the bottom of a drinks glass in order to release their flavor. However, by operating the muddler in the glass itself, only a very small quantity of flavoring agent can be used.

### SUMMARY

In one aspect, a system for flavoring a beverage comprises a hollow body that defines an interior volume. The interior volume is configured to receive a flavoring item and the hollow body is configured to be positionable within a larger volume defined by a beverage container. The hollow body comprises a plurality of apertures defined therethrough between the interior volume and the larger volume. The system further comprises a muddler configured to be received within the interior volume at a first end of the hollow body. The muddler is further configured to translate within the interior volume through a muddling action to muddle the flavoring item.

The muddler may include a skirt structured configured to contact an interior surface of the hollow body during at least a portion of the muddling action to modulate pressure therein. The skirt may be disposed along a length of the muddler between a first end comprising a handle end and a second end comprising a grinding end. The handle end may comprise a handle configured to be gripped by a user to translate the muddler within the internal volume. The grinding end may comprise a grinding surface configured to compress the flavor item when the muddler is translated within the interior volume. In certain embodiments, the skirt is positioned between the handle end and the grinding end such that the handle end comprises approximately 60-70% of the length of the muddler. In one embodiment, the skirt is formed of a silicone. In some embodiments, the skirt has a generally conical shape. In one embodiment, the skirt depends from the muddler at an angle of approximately 45 degrees. In one embodiment, the skirt is structured to increase and decrease the pressure within the internal volume during the muddling action to cause fluid circulation between the internal volume of the hollow body and the larger volume.

The plurality of apertures may include a mesh filter configured to filter passage of material between the interior volume and the larger volume. In one embodiment, the internal volume extends from a first end of the hollow body to a second end of the hollow body and includes a cross-section having a tapered portion that tapers toward the second end. The tapered portion may extend from the second end of the hollow body to a position configured to be level with the muddler skirt when the muddler is received within the interior volume and therein translated to the second end of the hollow body. In one embodiment, grinding bumps are provided on at least one of the grinding end of the muddler and a compression surface of the hollow body defining the internal volume.

In certain embodiments, the system further comprises a fitment positioned on an outer surface of the hollow body that is configured to attach the hollow body to the larger beverage container. The hollow body may include a handle pivotably mounted thereon to allow the hollow body to be easily placed and removed from the larger beverage container. In one embodiment, the hollow body comprises a core configured to modulate the flavor of a liquid contained within the larger volume of the beverage container. The larger beverage container may be a dispenser having a lid adapted to receive a plurality of interchangeable cores, each configured to modulate a characteristic of the liquid contained within the larger volume of the beverage container.

In another aspect, an infusion device is configured to be positioned within a beverage container comprises a hollow body portion, a muddler portion, and a filter portion. The hollow body portion comprises a first end and a second end and defines an interior volume configured to receive a flavoring item therein. The first end comprises a fitting configured to couple the hollow body portion to the beverage container at a complementary fitting. The muddler portion has an elongate body and extends from a first handle end to a second grinding end. The grinding end is configured to be received at the first end of the hollow body portion and translatable within the interior volume to muddle the flavoring item. The muddler portion comprises a skirt positioned between the first handle end and the second grinding end. A filter portion is disposed along the hollow body portion and is configured to provide a filter between the interior volume and an environment external to the interior volume.

The hollow body portion may further comprise a base configured to be removably positioned at the second end of the hollow body portion. The muddling portion may comprise a handle positioned at the first handle end configured to be gripped by a user to translate the grinding end within the internal volume. The muddling portion may be configured to compress the infusion item between a grinding surface positioned at the second grinding end of the muddling portion and a compression surface of the hollow body portion positioned within the interior volume. In various embodiments, at least one of the grinding surface and the compression surface comprises a plurality of grinding bumps positioned thereon configured to compressingly engage the infusion item when compressed there against. In some embodiments, the hollow body portion comprises a removable base. The removable base may comprise at least a portion of the compression surface. In one embodiment, the skirt is structured to contact an interior surface of the hollow body when the muddler is translated within the interior volume such that the pressure within the internal volume is modulated to motivate fluid circulation between the internal volume and the environment external to the interior volume.

In yet another aspect, a method of flavoring a beverage comprises providing a core configured to be inserted inside a first volume defined by a beverage container. The core comprises a wall defining a second volume therein that is less than the first volume, which is configured to receive a flavoring item. The wall defines a plurality of apertures therethrough. The method further comprises providing the beverage container wherein the first volume is configured to be filled with a beverage such that the beverage flows around the flavoring item through the plurality of apertures. The method further comprises providing a muddler configured to be inserted through a first end of the core and translated inside the second volume of the core to muddle the flavoring item within the second volume to release flavoring into the beverage and wherein the muddler includes a skirt configured to contact an interior surface of the wall of the core when the muddler is translated inside the second volume to modulate pressure therein.

### BRIEF DESCRIPTION OF THE DRAWINGS

FIG. 1 is a perspective view of a system according to various embodiments of the present disclosure.

FIG. 2 is another perspective view of the system of FIG. 1.

FIG. 3 is another perspective view of the system of FIG. 1.

FIG. 4 is another perspective view of the system of FIG. 1.

FIG. 5 is a perspective view of the muddler of the system of FIG. 1.

FIG. 6 is an end view of the muddler of FIG. 5

FIG. 7 is another end view of the muddler of FIG. 5.

FIG. 8 is a perspective view of the infusion core of the system of FIG. 1.

FIG. 9 is a side view of the infusion core of FIG. 8.

FIG. 10 is an exploded view of the infusion core of FIG. 8.

FIG. 11 is another exploded view of the infusion core of FIG. 8.

FIG. 12 is a top view of the infusion core of FIG. 8.

FIG. 13 is a bottom view of the infusion core of FIG. 8.

FIG. 14 is a sectional view of the infusion core of FIG. 8, taken along line 14-14 of FIG. 12.

FIG. 15 is another sectional view of the infusion core of FIG. 8, taken along line 15-15 of FIG. 12.

FIG. 16 is a sectional view of the muddler and infusion core.

FIG. 17 is another sectional view of the muddler and infusion core.

FIG. 18 is a perspective view of another system according to various embodiments of the present disclosure.

FIG. 19 is a side view of a cap according to various embodiments of the present disclosure.

### DETAILED DESCRIPTION OF THE INVENTION

A system for flavoring a beverage is disclosed. The system includes a core locatable inside a larger beverage container, the core having a wall including a plurality of apertures therein; and a muddler usable inside the core for mashing a flavoring element, the muddler including a skirt to prevent pieces of the flavoring element from escaping from the core.

The muddler skirt can separate a handle of the muddler from a grinding end. In one arrangement, the skirt can be located approximately 60-70% of the length of the muddler from the handle end. Preferably, the skirt is formed of silicon, although other flexible materials can be used. In some arrangements, the skirt has a generally conical shape, and may depend from the muddler at an angle of approximately 45 degrees.

The plurality of apertures can include a mesh filter. The portion of the core including the apertures can have a tapered shape. In some arrangements, the tapered shape of the core can extend from a base of the core to the level of the muddler skirt.

Grinding bumps can be provided on at least one of a grinding end of the muddler and a bottom of the core, preferably on both the grinding end of the muddler and on the bottom of the core, the grinding bumps allowing for easy mashing and grinding of the flavoring element.

In some arrangements, the container includes a fitment to enable the container to be attached to the larger beverage container. The core can include a handle to allow the core to be easily placed and removed from the larger beverage container, and the handle can be pivotally mounted to the core.

The larger beverage container can, in some arrangements, be a dispenser having a lid adapted to receive a plurality of interchangeable cores.

A method of flavoring a beverage is also disclosed. The method can include inserting a core inside a larger beverage container, the core having a wall including a plurality of apertures therein. A flavoring element such as fruit or herbs can be placed in the core. The method further includes filling the larger beverage container with a beverage, the beverage flowing around the flavoring element through the plurality of apertures in the core. A muddler is inserted into the core, the muddler including a skirt to prevent pieces of the flavoring element from escaping from the core. The method further includes using the muddler to mash the flavoring element to release flavoring into the beverage.

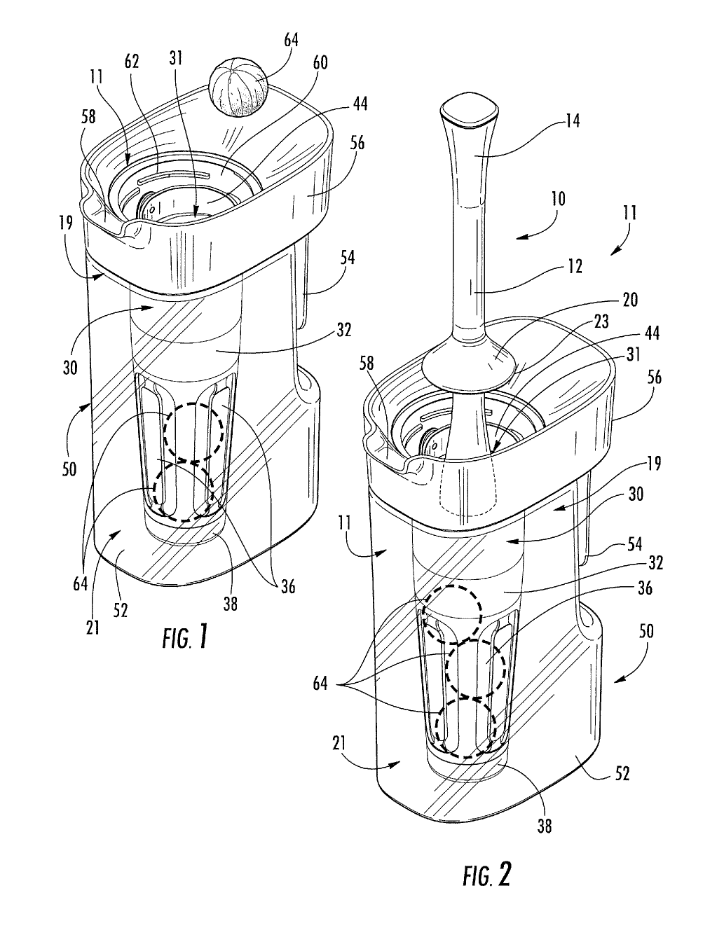

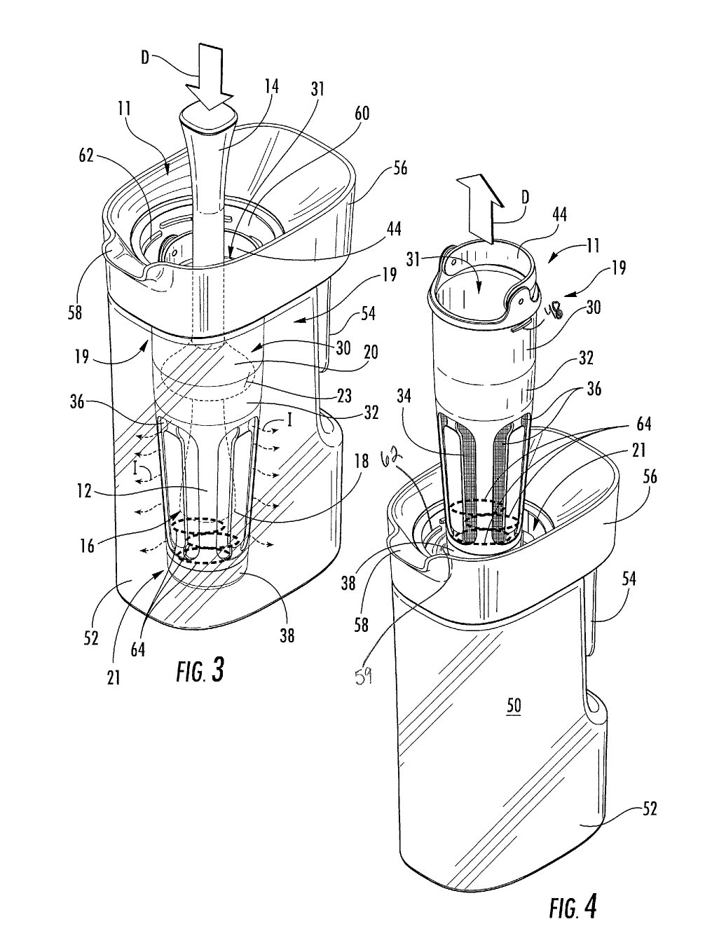

Referring to the drawings provided in FIGS. 1-19, systems and methods for flavoring beverages are illustrated. In particular, various views of a muddler 10 and an infusion core 11 comprising a hollow body 30 according to various embodiments are provided. The muddler 10 and infusion core 11 are generally usable in conjunction to muddle a flavoring item 64 received within an interior volume 31 of the hollow body 30 to release juices, components, or flavors into the interior volume 31 or environment external to the interior volume 31, e.g., within another volume, which may be a larger volume associated with the larger jug or dispenser 50. For example, as depicted in FIG. 1, one or more flavoring items 64 may be received within the interior volume 31 of the hollow body 30. A user may then position a grinding end 16 of the muddler 10 into the interior volume 31 through a first end 19 of the hollow body 30, as depicted in FIG. 2, and apply a muddling action at handle end 14 to translate the muddler 10 in the direction indicated by arrow D toward a base 38 or bottom of the interior volume 31, as depicted in FIG. 3. The muddling action may compresses the flavor items 64 at the bottom of the interior volume 31 causing a release of flavor, such as juices, from the flavor items 64 which may then pass through one or more apertures or openings 36 formed in a wall portion 32 of the hollow body 30, as generally indicated by hatched arrows I in FIG. 3, to thereby infuse a surrounding liquid.

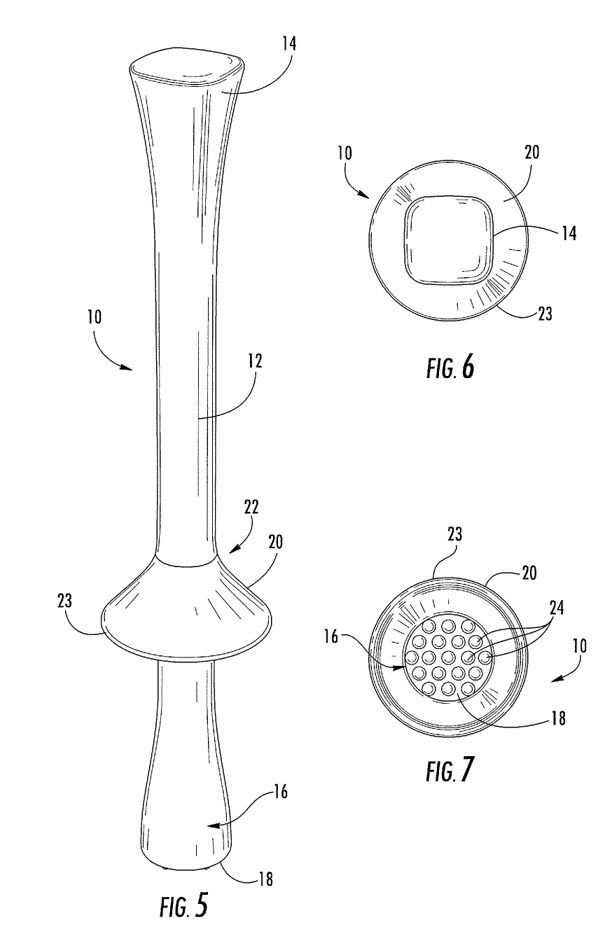

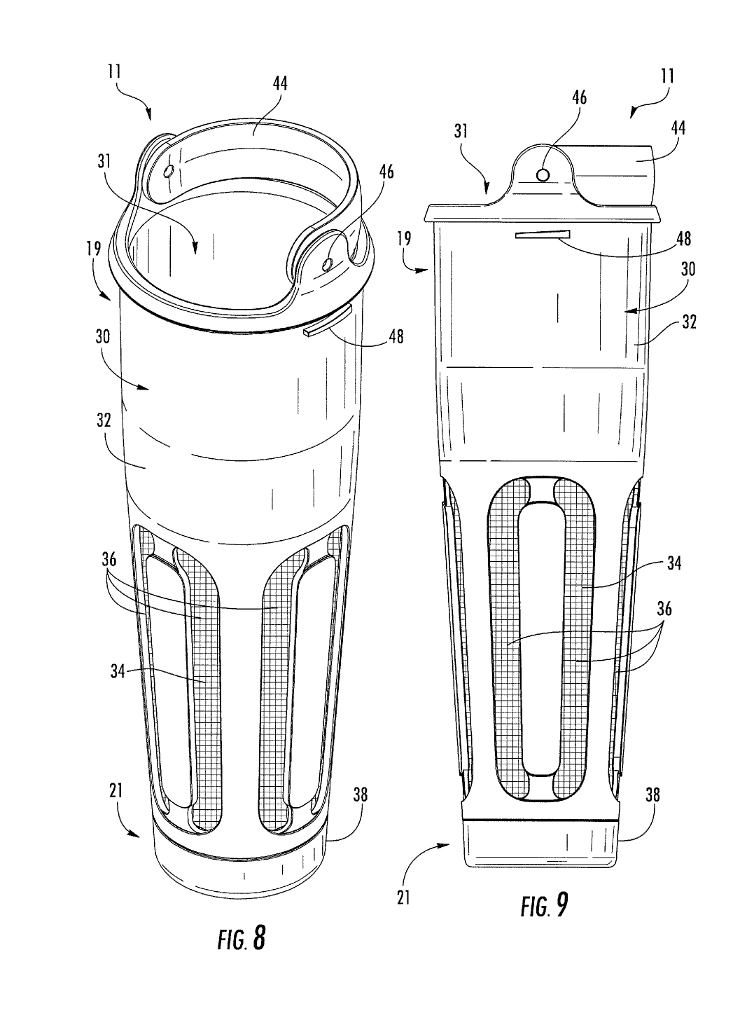

Various views of one embodiment of the muddler 10 (also known as a muddle stick), are shown in isolation in FIG. 5 (elevated view), FIG. 6 (top view), and FIG. 7 (bottom view). The muddler 10 comprises a stick 12 having a handle end 13 that incorporates a handle 14 and a grinding end 16 having a grinding surface 18. The muddler 10 further includes a skirt 20 disposed along a length of the stick 12 between the handle end 13 and the grinding end 16.

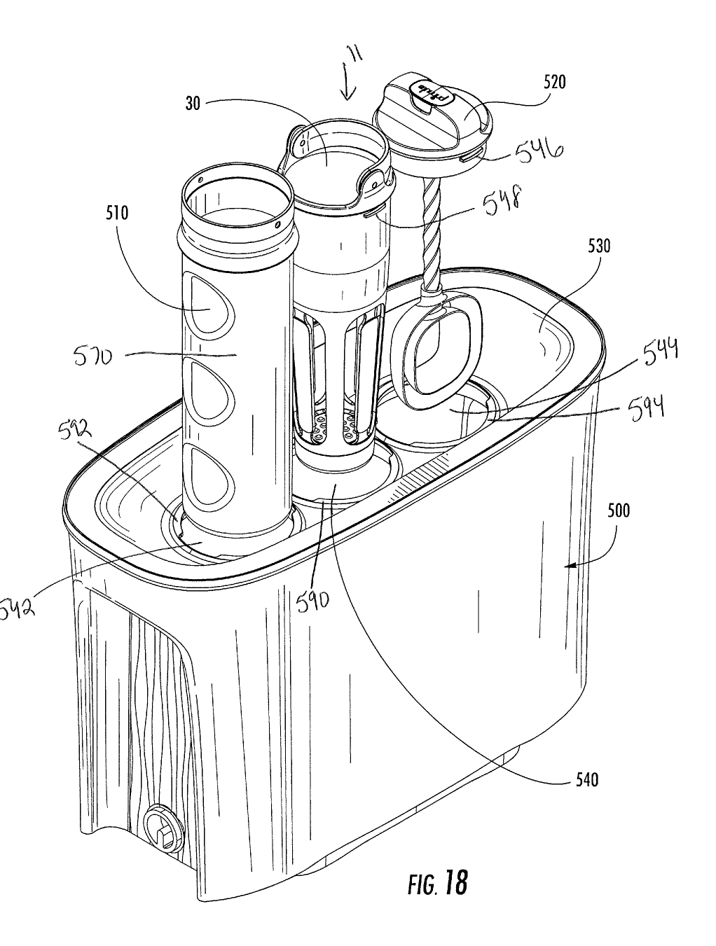

While the devices, systems, and methods disclosed herein may be adaptable to numerous muddling actions or operations, FIGS. 16 and 17 illustrate cross-sections of an infusion core 11 and muddler 10 depicting some of the various muddling actions that may be used according to the devices, systems, and methods disclosed herein. FIG. 17 depicts the muddler 10 in a down position following a downward muddling action in a direction generally indicated by arrow D. FIG. 17 also depicts a muddling action comprising a rotation generally indicated by arrow R. FIG. 16 depicts the muddler 10 in an up position following initial insertions (see FIG. 2) or following an upward action in a direction generally indicated by arrow P.

In various embodiments, the handle 14 may comprise features configured to assist grippability and manipulation of the muddler 10 and may, for example, include various ergonomic configurations to reduce grip fatigue during extended or repeated use. In one embodiment, the handle 14 may comprise surface features formed thereon. For example, surface features may comprise features configured to complement a contour of a hand of a user. Surface features may also be configured to increase grippability and may comprise non-slip materials or textures coated or otherwise positioned along the muddler 10. In one embodiment, the handle 14 comprises a compressible or elastomeric material such as a foam, rubber, or polymer, for example, configured to compressibly conform to the hand of the user. In one embodiment, the handle 14 comprises a thermally insulative material, for example, to reduce buildup of condensation on the handle 14 or reduce transfer of thermal energy between the muddler 10 and the user when the handle 14 is gripped. The grinding end 16 is configured to compressingly engaged with flavoring items 64 with the grinding surface as shown in FIGS. 1-3 in a muddling action.

In the embodiment of the muddler 10 illustrated in FIGS. 5-7, both the handle end 13 and the grinding end 16 flare outwardly from the stick body 12 to, for instance, make an operation or muddling action of the muddler 10 easier. For example, in one embodiment, an outwardly flared handle end 13 may increase grippability of the muddler 10 by reducing the likelihood the hand of the user may slide off an increased diameter of the outwardly flared handle end 13 when the muddler 10 is translated within the interior volume 31 defined by the hollow body 30. Similarly, in one embodiment, an outwardly flared grinding end 16 may increase the operative surface area of the muddler 10 without sacrificing volume, e.g., within the interior volume 31. Additionally, in some embodiments, the flared grinding end 16 is configured to improve circulation within the interior volume 31 of the hollow body 30 during a muddling action.

In some arrangements, the skirt 20 can be located along the length of the stick body 12 such that it may be positioned within the interior volume 31 of the hollow body 30 when the muddler 10 is translated therein. In one embodiment, the skirt 20 is located between about 60% and 70% along the length of the stick 12 from an end of the handle 14. The skirt 20 can be formed of silicon or any other suitable material, such as a flexible plastic, elastomer, or rubber material. In one embodiment, the skirt 20 preferably has a generally conical shape, and extends downwardly at an angle configured to retain or capture flavoring items 64 distal to the handle 14 during the muddling action. For example, the skirt 20 may be configured to prevent or limit portions of flavoring items 64 from escaping the interior volume 31.

In various embodiments, the skirt 20 is configured to extend outward of the muddler 10 to proximate with an interior surface of the wall 32 of the hollow body 30. For example, the skirt 20 may be configured to extend outward of the stick body 12 such that the an edge or outwardly extending surface of the skirt 20 contacts the interior surface of the wall 32 when the muddler 10 is translated within the internal volume 31. In some embodiments, the contact with the wall may create a seal or partial seal sufficient to modulate a pressure within the internal volume and therein motivate fluid to circulate through the internal volume 31. For example, in operation, a user may apply a muddling action at the handle end 14 to translate the muddler 10 a downward direction indicated by arrow D, as depicted in FIG. 3. A surface of the skirt 20 may contact the interior surface of the wall 32 of the hollow body 30 during at least a portion of the downward movement sufficient to increase pressure within the internal volume 31. The increase in pressure may motivate fluid within the internal volume 31 to flow outward of the internal volume 31, e.g., into the larger volume of the dispenser 50, during the downward movement. When a user applies a muddling action at the handle end 14 to translate the muddler 10 in an upward direction indicated by arrow P, as depicted in FIG. 16, a surface of the skirt 20 may contact the interior surface of the wall 32 of the hollow body 30 during at least a portion of the upward movement sufficient to decrease pressure within the internal volume 31. The decrease in pressure may motivate fluid flow inward toward and into the internal volume 31, e.g., from the larger volume of the dispenser 50. Thus, in various embodiments, the muddling action may modulate pressure within the internal volume 31 to include creation of alternating increases and decreases in pressure, e.g., positive and negative pressures or pressure fluctuation, via the skirt 20. Circulation of fluid within the system may therefore be enhanced due to such modulation of alternating pressures during the muddling action.

According to one embodiment, the muddler 10 may be configured for operation similar to that of a piston translating within a cylinder through a stroke. For example, as the muddler 10 is manipulated through an upward and downward muddling action, or stroke, an outward extending surface of the skirt 20 contacts the inner surface of the wall 32 similar to a compression ring contacting a cylinder wall to modulate pressure within the internal volume 31 of the hollow body 30. As such, a pumping action may be created with respect to the fluid, thereby encouraging circulation and speeding flavor extraction from the flavoring items 64. Thus, in some embodiments, the skirt 20 may be configured to impart a percolation operation to the system or device when the muddler 10 is manipulated through a pump-like muddling action such that fluid flows circulate through the internal volume 31 containing the flavoring items 64 to enhance extraction of flavor. In various embodiments, the outwardly extending surface of the skirt 20 is configured to contact the interior surface of the wall 32 and comprises a surface configuration configured to enhance desirable contact between the skirt 20 and the wall 32. For example, the outwardly extending surface may comprise one or more rings or ridges formed thereon configured to contact the interior surface of the wall 32. In some embodiments, the skirt 20 may comprise multiple outwardly extending surfaces, or multiple skirts 20, configured to contact the interior surface of the wall 32. The outwardly extending surface may further comprise contact points on multiple sides of the skirt 20 that are configured to contact the inner surface of the wall 32 during particular points in the muddling action.

In various embodiments, the outwardly extending arrangement of the skirt 20 may beneficially limit loss or spillage or flavoring items during the muddling action, e.g., via deflection of splashes or errant ejection of particulates of the flavoring item 64 or other liquid. For example, in one embodiment, the skirt 20 comprises an outer edge or rim 23 configured to engage, scrape, or otherwise pass along an interior surface the wall 32 of the hollow body 30 of the infuser core 11 to congregate flavoring items 64 toward a bottom or second end 21 of the hollow body 30.

In the embodiment illustrated in FIGS. 5-7, the skirt 20 extends downwardly at an angle of approximately 45 degrees towards the grinding end 16 from an attachment point 22. The attachment point 22 preferably includes a relatively thick layer of silicon or other material configured to provide strength to the skirt 20. For example, the material or structure may be configured to provide rigidity sufficient to prevent significant or complete proximal or upward flexing of the skirt 20. In some embodiments, as illustrated in the embodiment including a muddler 10 shown in FIGS. 16 and 17, the muddler 10 may incorporate a cut-out portion 25 on the stick 12 into which a portion of the skirt 20 seats. In various embodiments, the attachment point 22 of the skirt 20 may be configured to elastically stretch such that an opening defined through a central portion of the skirt 20 may be received at the handle end 13 or grinding end 16 in order to position the skirt 20 at the cut-out portion 25. Thus, in some embodiments, the skirt 20 may be configured to be a modular component that may be added or removed for cleaning, replacement due to wear, or exchange with a skirt 20 comprising a different configuration designed to more closely suit a desired muddling action or cross-section of a hollow body 30. In some embodiments, the skirt 20 may conform to the cut-out portion 25 or may be movably associated with the cut-out portion 25, e.g., rotatably or slidably, to adjust a distance between the skirt 20 and the handle end 13 or grinding end. Furthermore, the attachment point 22 may include a curved under surface 27 of the skirt 20, to deflect pieces of flavoring items downwardly, as described above, and prevent them becoming stuck. The outer surface of the skirt 20 preferably blends smoothly with the surface of the stick 12, to enable the muddler 10 to be cleaned easily.

As most clearing shown in the bottom view of the muddler 10 provided in FIG. 7, the grinding end 16 of the muddler 10 comprising one or more muddling features comprising grinding bumps 24 located on the grinding surface 18 of the muddler 10, which are configured to compressingly engage and muddle flavoring items 64 within the interior volume 31 when the muddler is translated within therein. The grinding bumps 24 may be small circular bumps, as illustrated in FIG. 7, that are provided in any suitable pattern on the grinding surface 18.

Although the type of muddling features may vary by application, among the suitable structures and arrangements are raised or recessed features, e.g., bumps, ridges, teeth, or serrations. In various embodiments, the muddling features may also be disposed along a portion of the grinding end 16 adjacent to the grinding surface 18 positioned at the bottom of the muddler 10. That is, in various embodiments, the grinding surface 18 may extend to the sides or outwardly flared portion of the grinding end 16 to, for example, compressingly engage and muddle flavor items 64 at such positions along the muddler 10. The muddling features may comprise similar or different material as the portion of the muddler 10 upon which it is formed including, but not limited to, metals, alloys, ceramics, polymers, hard plastics, elastomers, rubbers, thermoplastics, and thermosets. In one embodiment, for example, the muddling features comprise metal structures formed on the grinding end 16. The muddling features may be provided in various patterns, which may comprise characteristic patterns and structures configured for specialized or enhanced muddling of certain types or combinations of flavor items 64. For example, the number, length, thickness, surface texture, smoothness, pattern, and orientation of muddling features 42 may be designed for optimal extraction of juices from flavor items 64.

In one embodiment, the muddler 10 comprises two or more modular components configured for interchangeability. For example, the handle end 13 or handle 14 may be configured to be removably coupled to the stick 12, skirt 20, or grinding end 16. In one embodiment, the grinding end 16 may be coupleable, e.g., via threads, to the stick 12 such that a grinding end 16 comprising a first configuration of muddling features may be selectively exchanged with a second grinding end 16 comprising a second configuration of muddling features. As such, a user may assemble customized configurations of handles 14, skirts 20, and grinding ends 16 to suit a desired muddling operation, hollow body 30, or flavoring item 64. Notably, whether or not the muddler 10 comprises modular features, the various components or portions of the muddler 10 may comprise same or dissimilar combinations of materials.

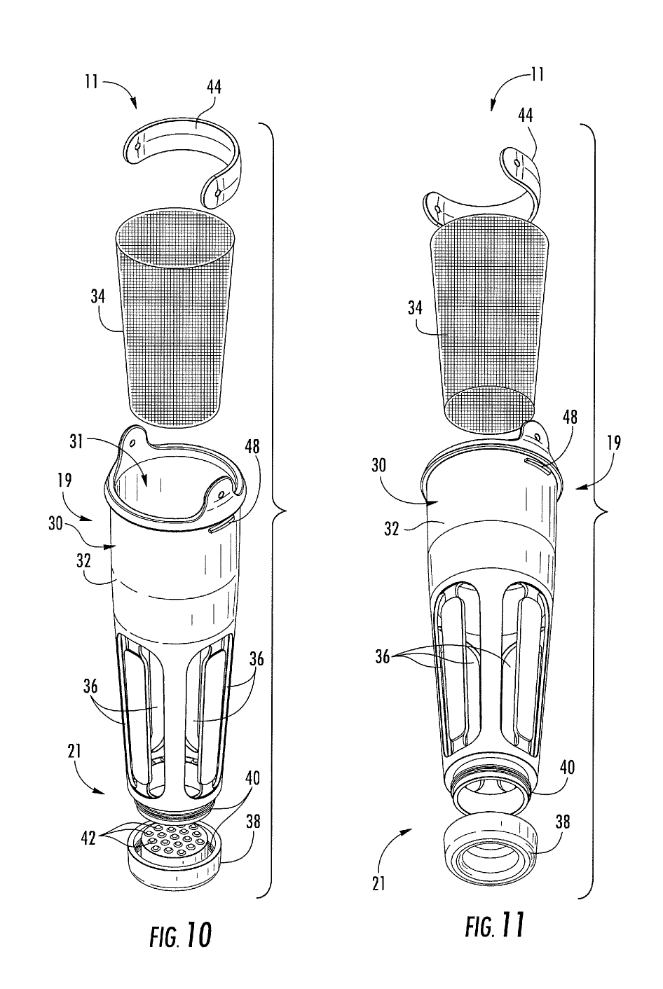

In various embodiments, referring generally to FIGS. 1-4 and 18 and more specifically to FIGS. 8-17 illustrating various isolated views of the hollow body 30 of the infusion core 11, the hollow body 30 may generally comprise a cup-shaped vessel defining the interior volume 31 configured to receive one or more flavoring items 64. The hollow body 30 is formed of a slightly tapered or cylindrical wall portion 32, and in some arrangement an upper portion near the first end 19 of the hollow body 30 is cylindrical while a lower portion near the second end 21 may be slightly tapered distally towards a smaller bottom. Notably, is some embodiments, the wall portion 32 may include a portion that tapers toward the upper portion near the first end 19 or does not taper. In certain embodiments, the hollow body 30 comprises wall portions 32 that define interior volumes 31 having non-annular cross-sections such as cross-sections comprising geometric, non-geometric, or irregular shapes. In some such embodiments, the muddler 10 may comprise a complementary cross-section, e.g., along the handle end 13, skirt 20, or grinding end 16.

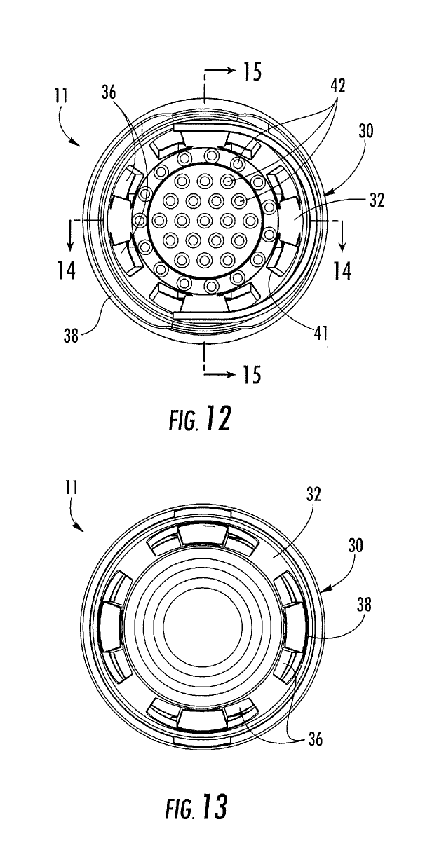

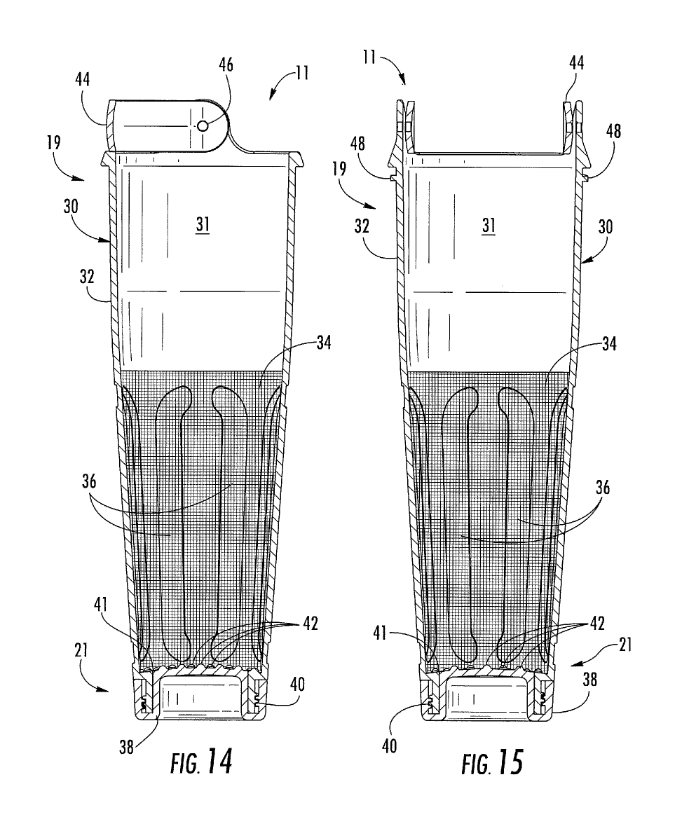

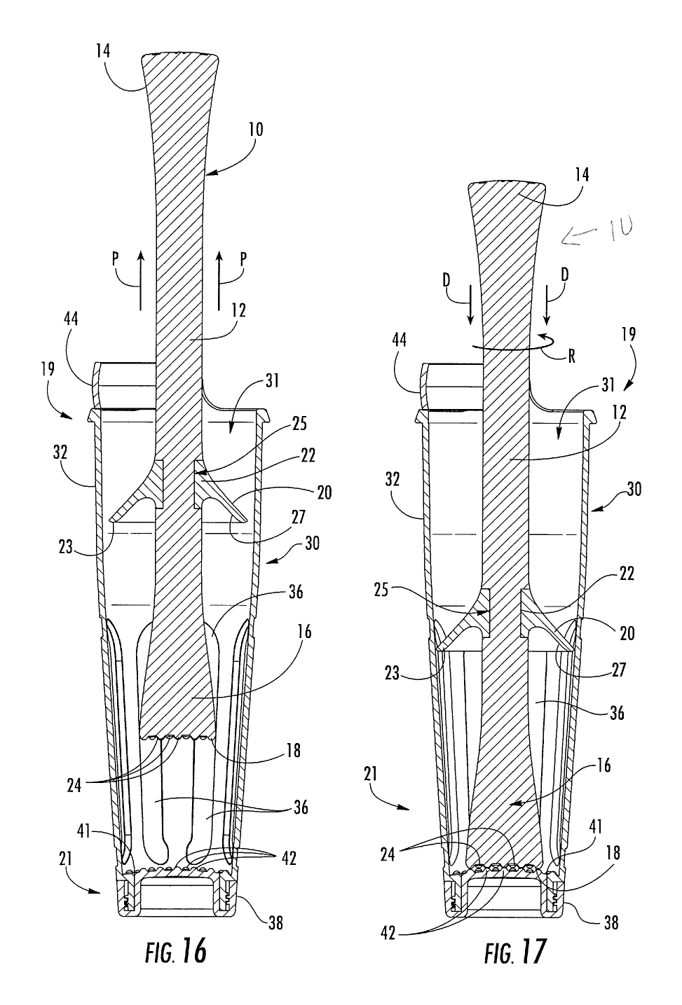

A lower portion of the wall portion 32 near the second end 21 includes at least one mesh filter section or panel 34, as most clearly shown in elevated views illustrated in FIGS. 8 and 9, the exploded views illustrated in FIGS. 10 and 11, and the cross-sectional views illustrated in FIGS. 14 and 15 (taken lines 14-14 and 15-15 of FIG. 12, respectively). In the illustrated embodiments, a plurality of openings 36 are provided in the wall portion 32 that are covered by the mesh filter 34. The mesh filter 34 can be a single piece of mesh fabric or other material that can encircle the inside of the wall portion 32, or separate panels of mesh can be attached to the openings 36. The mesh filter 34 is positioned between the interior volume 31 defined by the hollow body 30 and the environment external to the interior volume 31. Accordingly, the mesh filter 34 is configured to provide a filter there between. In various embodiments, the mesh filter 34 comprises a thread count configured to be permeable to flavors or juices extracted from flavor items 64. In these or other embodiments, the mesh filter 34 may also comprise a thread count configured to selectively filter particulates based on size or other characteristic of the particulate such as a charge, repulsion, or affinity.

In various embodiments, the second end 21 of the hollow body 30 comprises a removable bottom cap 38, that can be attached to the wall portion 32. However, is certain embodiments, the hollow body comprises a bottom cap 38 that is integral with the wall portion 32. A removable bottom cap 38 may be coupled or attached to the wall portion 32 in any suitable manner configured to retain the bottom cap 38 at the wall portion 32 including compression, friction, snaps, clips, grooves, etc. In the embodiments illustrated in FIGS. 8-17, the bottom cap 38 is configured to attach to the wall portion 32 via complementary screw threads 40 provided on both the wall portion 32 and the bottom cap 38. The removable bottom cap 38 can allow for easy cleaning of the infusion core 11.

An interior surface of at the second end 21 of the hollow body 30, e.g., the bottom cap 38, can also include various muddling features configured to compressingly engage the flavor items 64 when the muddler 10 is operated to muddle the flavor items 64. The various types of suitable muddling features may be as described above with respect to the muddler 10 and may be provided in various structures, configurations, arrangements, and patterns suitable to muddle the flavor 64 items. In certain embodiments, for example, the muddling features may comprise the same or a different pattern, structure, or material as muddling features disposed on the muddler 10. For example, in one embodiment, the muddling features disposed at the bottom of the interior volume 31 may comprise a complementary pattern with respect to the muddling features disposed at the grinding surface 18 or the muddler 10. In the embodiments illustrated in FIGS. 10, 12, and 14-17, various muddling features are disposed at the bottom of the interior volume 31. The muddling features include grinding bumps 41, 42 positioned on a compression surface 43 at the second end 21 that defines a bottom surface of the interior volume 31 and which may include the bottom cap 38. The grinding bumps 41, 42 are structured and patterned in a complementary manner with respect to the to the grinding bumps 24 disposed on the grinding surface 18 of the muddler 10. As described above, grinding bumps 41, 42 may be small circular bumps that can be provided in any suitable pattern on the bottom cap 36. As shown in FIG. 12, providing a top view of the core 30, a row of grinding bumps 41 may be positioned at the compression surface 43 within the inner volume 31. The grinding bumps 41 are positioned around a perimeter of the wall portion 32 within the inner volume 31. The bottom cap 36 is shown attached to the wall portion 32 of the hollow body 30 and includes grinding bumps 42 formed on a surface thereof similar to grinding bumps 41. FIG. 13 illustrates a bottom view of the core 30 wherein the bottom cap 36 is shown attached to the wall portion 32 of the hollow body 30.

A handle 44 can be provided on an upper end of the infusion core 11, and may be articulated about a pivot hinge 46. An upper part of the wall section 32 may include a fitment 48, for fitting the infusion core 11 into a drinks dispenser.

The muddler 10 is sized to be a relatively close fit inside the hollow body 30, with the skirt 20 extending to proximate or touch the interior of the wall section 32 at one or more points of the muddling action, as depicted in FIGS. 16 and 17. The grinding bumps 24 provided on the muddler 10, and the grinding bumps 41, 42 provided on the compression surface 43, including the bottom cap 38, meet one another when the muddler 10 is within the core 30. Such a complementary configuration of muddling features may enhance the muddling action with, for example, highly compressible flavor items 64. A sufficient length of handle 14 protrudes from the open end of the infuser core 11 to allow a user to grasp and manipulate the handle 14.

In use, the infusion core 11 can be inserted into a beverage dispenser or jug 50. FIGS. 1-4 show the infusion core 11 used with a jug. The jug 50 comprises a lower beverage container 52 defining a larger volume than the interior volume 31 of the hollow body 30 and includes a handle 54 and a lid portion 56. The lid portion 56 can include a pouring spout 58, and an aperture 60 for receiving the core 30. The aperture 60 can include a threaded portion 62 which may be configured to engage complementary threads 70 disposed on a cap 72, as shown in FIG. 19, configured to provide a seal at the aperture 60 of the lid portion 56 along surface 74 of the cap 72. The cap 72 also includes a handle 76 configured to be gripped by a user to rotate the cap 72 into a locking fitment with the lid portion 56. In various embodiments, the cap 72 may be positioned in the aperture 60 over the hollow body 30 or when the hollow body 30 is not received within the larger volume of the jug 50. The lid portion 56 further comprises a fitment comprising one or more grooves 59, as generally shown in FIG. 2, configured to engage the fitment 48 on the hollow body 30 to allow the infusion core 11 to be held in position by the lid portion 56. In some embodiments, for example, the infusion core 11 may be inserted into the aperture 60 and snapped or rotated into a compression or frictional fitment with the lid portion 56, which in certain embodiments may stably associated, e.g., essentially lock, the infusion core 11 within the aperture 60 of the lid portion 56.

After the infusion core 11 has been fitted into the jug 50, flavoring items 64 can be placed within the interior volume 31 (as shown in FIG. 1). The flavoring items 64 are generally fresh fruits and herbs, but can be any combination of crushable foods and/or flavorings. The jug 50 can then be filled with water or another beverage such as tea. To quickly release the flavoring from the flavoring items 64 into the beverage, the muddler 10 is inserted into the core (as shown in FIG. 2), and used to crush the flavoring items 64 in a muddling action that involves moving the muddler up and down with the interior volume 31 (as shown in FIG. 3). The grinding bumps 24 and 41, 42 are used together by grinding the muddler 10 towards the bottom cap 38 of the infusion core 11 to mash the flavoring items to release as much of the fruit juice or other flavorings as possible. While the flared grinding end 16 helps to retain much of the pulped flavoring items in place, the skirt 20 also prevents pulp or pieces of the flavoring items 64 from spilling out of the interior volume 31, and also helps pieces of flavoring items 64 to recirculate down to the bottom of the hollow body 30 for further crushing at the second end 21 between the compression surface 43 and the grinding end 16. The mesh-covered openings 36 enable the released juices or other flavorings to circulate to the beverage while retaining any leftover pulp within the interior volume 31. After use, the muddler 10 can be removed from the interior volume 31 defined by the hollow body 30, and either the beverage can be poured from the jug 50 with the infusion core 11 remaining in place, or the infusion core 11 can be removed from the jug 50 (as shown in FIG. 4) prior to pouring.

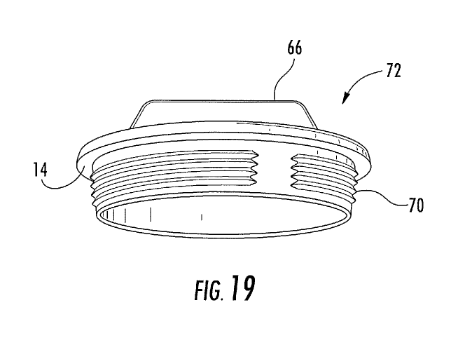

In some arrangements, for example as shown in FIG. 18, a large dispenser 500 may be used. In this dispenser, a plurality of interchangeable cores may be used, for example, a chiller core 510, an infusion core 11 according to the present disclosure, and an agitator core 520. The chiller core 510 can be made of a freezable material that can chill the beverage without diluting it. The agitator core 520 can be used to stir the beverage, while the infusion core 11 can be used to flavor the beverage. The various cores 11, 510, 520 seat into a lid 530 having a plurality of apertures 540, 542, 546 capable of receiving the interchangeable cores. For example, the lid 530 comprises fitments 590, 592, 594 positioned at each aperture 540, 542, 544 configured to interchangeably receive cores having complementary fittings, e.g., tabs 546, 548. While the ice core 510 is shown without a complementary fitting, in various embodiments, an ice core 510 comprises a complementary fitting positioned thereon, such as on an outer surface 570 of the core 510 or sleeve (not shown) configured to retain the core 510. Other cores could be used in place of the illustrated cores, for example, a tea strainer core (not shown) can be used to brew tea at the same time that the infusion core 11 is used to flavor the tea with fruit juices.

It is important to note that the methods described above may incorporate any of the functionality, devices, and/or features of the apparatuses described above, or otherwise, and are not intended to be limited to the description or examples provided herein.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system for flavoring a beverage comprising:
a hollow body defining an interior volume configured to receive a flavoring item, the hollow body configured to be positionable within a larger volume defined by a beverage container, wherein the hollow body comprises a plurality of apertures defined therethrough between the interior volume and the larger volume; and
a muddler configured to be received within the interior volume at a first end of the hollow body and therein translate through a muddling action to muddle the flavoring item, the muddler including a skirt structured to contact an interior surface of the hollow body during at least a portion of the muddling action to modulate pressure therein.

2. The system of claim 1, wherein the skirt is disposed along a length of the muddler between a first end comprising a handle end and a second end comprising a grinding end, wherein the handle end comprises a handle configured to be gripped by a user to translate the muddler within the internal volume, and wherein the grinding end comprises a grinding surface configured to compress the flavor item when the muddler is translated within the interior volume.

3. The system of claim 2, wherein the skirt is positioned between the handle end and the grinding end such that the handle end comprises approximately 60-70% of the length of the muddler.

4. The system of claim 1, wherein the skirt is formed of a silicone.

5. The system of claim 1, wherein the skirt has a generally conical shape.

6. The system of claim 1, wherein the skirt depends from the muddler at an angle of approximately 45 degrees.

7. The system of claim 1, wherein the plurality of apertures includes a mesh filter configured to filter passage of material between the interior volume and the larger volume.

8. The system of claim 1, wherein the internal volume extends from a first end of the hollow body to a second end of the hollow body and includes a cross-section having a tapered portion that tapers toward the second end.

9. The system of claim 8, wherein the tapered portion extends from the second end of the hollow body to a position configured to be level with the muddler skirt when the muddler is received within the interior volume and translated to the second end of the hollow body.

10. The system of claim 1, wherein grinding bumps are provided on at least one of the grinding end of the muddler and a surface of the hollow body defining the internal volume.

11. The system of claim 1, further comprising a fitment positioned on an outer surface of the hollow body configured to attach the hollow body to the larger beverage container.

12. The system of claim 1, wherein the skirt is structured to increase and decrease the pressure within the internal volume during the muddling action to cause fluid circulation between the internal volume of the hollow body and the larger volume.

13. The system of claim 1, wherein the hollow body comprises a core configured to modulate the flavor of a liquid contained within the larger volume of the beverage container.

14. The system of claim 13, wherein the larger beverage container is a dispenser having a lid adapted to receive a plurality of interchangeable cores each configured to modulate a characteristic of the liquid contained within the larger volume of the beverage container.

15. An infusion device configured to be positioned within a beverage container, the infusion device comprising:
a hollow body portion comprising a first end and a second end and defining an interior volume configured to receive a flavoring item therein, the first end comprising a fitting configured to couple the hollow body portion to the beverage container at a complementary fitting;
a muddler portion having an elongate body extending from a first handle end to a second grinding end, wherein the grinding end is configured to be received at the first end of the hollow body portion and translatable within the interior volume to muddle the flavoring item, wherein the muddler portion comprises a skirt positioned between the first handle end and the second grinding; and
a filter portion disposed along the hollow body portion and configured to provide a filter between the interior volume and an environment external to the interior volume.

16. The infusion device of claim 15, wherein the hollow body portion further comprises a base configured to be removably positioned at the second end of the hollow body portion.

17. The infusion device of claim 15, wherein the muddling portion comprises a handle positioned at the first handle end configured to be gripped by a user to translate the grinding end within the internal volume, wherein the muddling portion is configured to compress the infusion item between a grinding surface positioned at the second grinding end of the muddling portion and a compression surface of the hollow body portion positioned within the interior volume.

18. The infusion device of claim 17, wherein at least one of the grinding surface and the compression surface comprises a plurality of grinding bumps positioned thereon configured to compressingly engage the infusion item when compressed there against.

19. The infusion device of claim 18, wherein the hollow body portion comprises a removable base, and wherein the removable base comprises at least a portion of the compression surface.

20. The infusion device of claim 15, wherein the skirt is structured to contact an interior surface of the hollow body when the muddler is translated within the interior volume such that the pressure within the internal volume is modulated to motivate fluid circulation between the internal volume and the environment external to the interior volume.

21. A method of flavoring a beverage, comprising the steps of:
providing a core configured to be inserted inside a first volume defined by a beverage container, the core comprising a wall defining a second volume less than the first volume and configured to receive a flavoring item, and wherein the wall defines a plurality of apertures therethrough;
providing the beverage container wherein the first volume is configured to be filled with a beverage such that the beverage flows around the flavoring item through the plurality of apertures; and
providing a muddler configured to be inserted through a first end of the core and translated inside the second volume of the core to muddle the flavoring item therein to release flavoring into the beverage, the muddler including a skirt configured to contact an interior surface of the wall of the core when the muddler is translated inside the second volume to modulate pressure therein.
